(19) United States
(12) Patent Application Publication
(10) Pub. No.: US 2006/0011572 A1
(43) Pub. Date: Jan. 19, 2006

(54) Infant nursing nipple

(76) Inventor: William D. Pegg, Bethesda, MD (US)

Correspondence Address: William D. Pegg, 1225 Dartmouth Street, Wilmette, IL, 60091, US

(21) Appl. No.: 11/184,016

(22) Filed: Feb. 20, 2004

(51) Int. Cl. A61J 11/00; A61J 9/00

(52) U.S. Cl. 215/11.1

(57) ABSTRACT

A nipple for use with a baby bottle includes a hollow body having a tip at one end and a base at another end, the tip having an opening adapted to pass fluid and the base having a flange for securement of the nipple to a bottle and bi-lateral projections provided on the body to extend outwardly from the body and to extend lengthwise along at least a portion of the body between the tip and the base. The cross-sectional shape of the nipple having such bi-lateral extensions approximates the actual shape of an infant's or baby's mouth, including the very corner of the mouth, during suckling, to thereby at least partially occlude a gap formed between conventional nipples and the corner of an infant's or baby's mouth.

### TECHNICAL FIELD

The present invention relates to an improved nipple for use in combination with a nursing bottle for an infant, and more particularly, to an improved nipple having projecting portions adapted to at least partially occlude by a non-circular cross-section.

### BACKGROUND OF THE INVENTION

Conventional nursing nipples, commonly used to feed infants and toddlers milk, formula, juices and other fluids, comprise a hollow rubber shell with a feeding-tip extending from a bulbous portion, which is carried on a flange. Conventional wisdom in the field strives toward achieving a closer and closer approximation to a mother's breast.

Most recently, Pechenik et al. (U.S. Pat. No. 6,588,613 B1) developed a nursing nipple which seeks to mimic the function of the human breast nipple by simulating laciferous ducts using at least one hydrophilic fluid delivery passage, such as a microtube or a microchannel, to thereby deliver a continuous supply of milk without entrained air and without requiring hard sucking on the part of the infant. In so doing, Pechenik et al. promulgate the conventional wisdom and rhetoric that the natural nipple as the ideal and describe their attempt as striving to best “resemble[s] the human breast nipple and its positive attributes”.

A consistent problem in the development of suitable alternatives to breast feeding have all encountered problems with air intake into the infant's stomach during feeding. Unless one or both of the nipple or bottle are provided with a vent system, a partial vacuum is formed within the bottle as the baby sucks on the nipple and withdraws the fluid. This vacuum makes it more difficult for the baby to feed, as it requires the baby to suck with much greater force, which can discourage the baby and cause it to stop feeding sooner than desired. Accordingly, a variety of vented bottle assemblies have been developed.

One conventional bottle assembly, U.S. Pat. No. 6,053,342 to Chomik, issued Apr. 25, 2000, utilizes a bottle having a first open end and a second open end, a nipple assembly affixed to the first open end, a vented cap affixed to the second open end, and an elastomeric diaphragm affixed to the second open end by the vented cap, wherein the vented cap has at least one slot and the elastomeric diaphragm has a plurality of resealable perforations and at least one integral tab extending therefrom.

However, even with the improvements realized by the commercially available nursing nipples, infants still swallow appreciable quantities of air and require burping, sometimes in lengthy sessions, to eliminate such ingested air. This labor of love is particularly burdensome during the nighttime hours. Thus, a need exists for an improved nursing nipple which minimizes or avoids the ingestion of air by infants during suckling.

### SUMMARY OF THE INVENTION

Accordingly, it is an object of the present invention to provide a nursing nipple that approximates in shape an infant's-mouth during suckling, inclusive of the corners of the mouth.

In one aspect, a nipple for use with a baby bottle, comprises a body having an opening at a proximal end adapted to pass fluid and a distal end having a flange adapted to connect the body to a baby bottle. Over at least a portion of a length of the body between the proximal end and the distal end, the body comprises bi-lateral projecting portions having a local maximum dimension from a center axis of the nipple to an apex of the bi-lateral projecting portions greater than a corresponding maximum dimension of the body along remaining portions of the body along the length of the bi-lateral projecting portions. In this aspect, a local maximum dimension of the bi-lateral projecting portions from the center axis of the nipple is between about 0.25 mm to 5.0 mm and an angle formed between the bi-lateral projecting portions along a length of the bi-lateral projecting portions is between 180° and about 120°.

In another aspect, a nipple for use with a baby bottle, comprises a hollow body having a tip at one end and a base at another end, the tip having an opening adapted to pass fluid and the base having a flange for securement of the nipple to a bottle and bi-lateral projections provided on the body to extend outwardly from the body. The bi-lateral projections extend lengthwise along at least a portion of the body between the tip and the base.

In still another aspect, a nipple for use with a baby bottle, comprises a hollow body having a tip at one end and a base at another end, the tip having an opening adapted to pass fluid and the base having a flange for securement of the nipple to a bottle, the hollow body having, over a length thereof, a cross-sectional shape defined by a first base curvilinear profile on an upper portion thereof and by a second base curvilinear portion on at least a portion of a lower portion thereof and projecting portions extending outwardly from the second base curvilinear portion over at least a portion of the length of the hollow body. In this aspect, an angle formed between the respective projecting portions along a length thereof is between 180° and about 120°.

Other objects and advantages of the invention will be set forth in part in the description which follows, and in part will be obvious from the description, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and form a part of the specification, illustrate non-limiting examples of embodiments of the present invention and, together with the description, serve to explain the principles of the invention.

FIG. 1 is a perspective view of a first example of a nipple in accord with the present concepts;

FIG. 2 is a side view of the first example of a nipple in accord with the present concepts;

FIG. 3 is another side view of the first example of a nipple in accord with the present concepts;

FIG. 4 is a top view of the first example of a nipple in accord with the present concepts;

FIG. 5 is a perspective view of a second example of a nipple in accord with the present concepts;

FIG. 6 is a top view of the second example of a nipple in accord with the present concepts;

FIG. 7 is a perspective view of a third example of a nipple in accord with the present concepts;

FIG. 8 is a top view of the third example of a nipple in accord with the present concepts;

FIG. 9 depicts the incomplete seal formed between an infant's mouth and a conventional nipple during suckling.

### DETAILED DESCRIPTION OF THE INVENTION

In the following description, for the purposes of explanation, numerous specific details are set forth in order to provide a more thorough understanding of the present invention. It will be apparent, however, that the general precepts disclosed herein may be embodied in alternative forms not expressly depicted in the accompanying figures.

This inventor has observed that a primary source of air-intake during suckling occurs through the corner of the mouth, as the conventional nursing nipples are not resilient enough to accommodate this portion of the mouth and as the infant's and baby's oral musculature, particularly the orbicularis oris muscle, which encircles the mouth and permits closure and puckering of the lips, is apparently insufficiently developed to force the mouth shape into exact compliance to the nipple for periods of time sufficient to complete feeding. While infants are able to temporarily or intermittently conform their lips and mouths to suckle a nursing nipple of circular cross-section, infants are often unable (or perhaps unwilling) to consistently maintain a uniform seal on the nipple, thereby allowing ingestion of air through the corners of the mouth.

FIG. 9 represents a view of the corner of an infant's mouth suckling on a conventional nipple N. A gap G is present at the corner of the infant's mouth, as the infant is not able to completely conform his or her mouth to the circular cross-section of the conventional nipple. A mother's breast is sufficiently compliant to permit the infant to develop a complete and highly effective seal. Conventional elastomeric nipples N are not sufficiently compliant to consistently or reliably permit the nipple material to deform to fill gap G. Correspondingly, the gap G correspondingly permits significant air ingress and ingestion by the infant. In accord with the examples and the concepts disclosed herein, a bi-lateral extensions are provided on opposing sides of the nipple to extend into the gap G to at least partially occlude the gap and limit or eliminate air ingestion through this pathway.

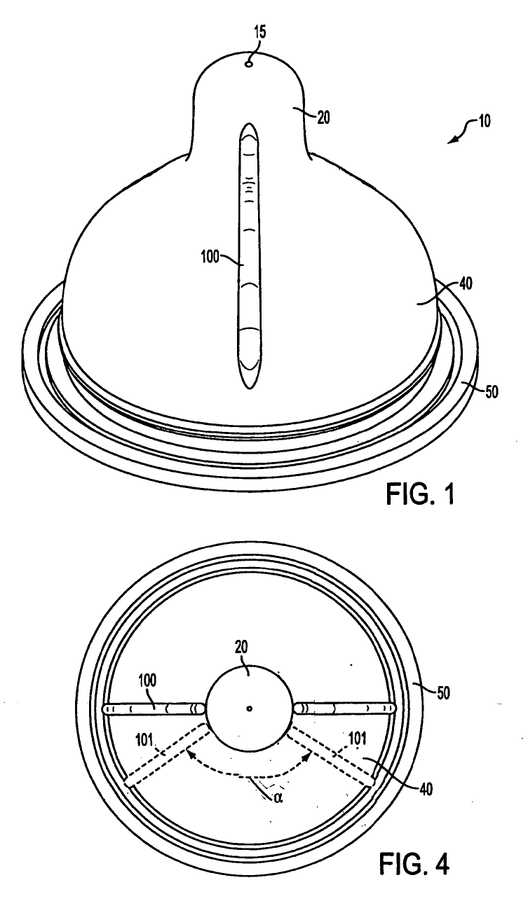

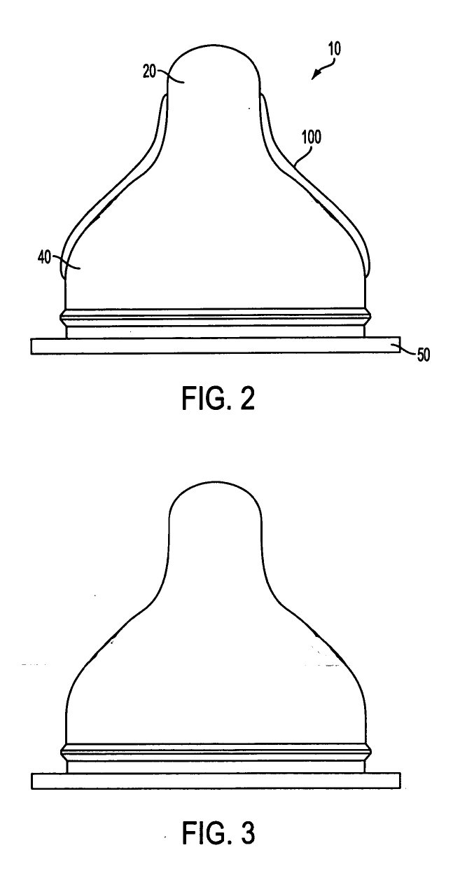

FIGS. 1-4 show one example of a nipple 10 in accord with the present concepts. In one aspect, the nipple 10 may be used in combination with a conventional plastic or glass baby bottle, not shown. Nipple 10 may be formed from one or more conventional elastomeric materials including, but not limited to, silicone rubber or latex in accord with current practices and methods. For example, nipple 10 may be die molded or formed in a process comprising injecting a liquid elastomer (e.g., liquid silicone rubber) through one or more ports in a mold.

Nipple 10 has a tip 20, typically rounded, bearing on outlet opening 15 at its top end. The outlet opening may comprise one or more holes and/or slits sufficiently sized and shaped, in combination, to provide a level of output flow consistent with an intake ability of a baby or infant at at least one selected stage of development, as conventionally practiced. Tip 20 may be flat, angled, or may assume another profile or shape. Below the tip 20, the nipple 10 flares outwardly to form the body 40 of the nipple. The body 40 of the nipple 10 may comprise one or more visually distinct sections, such as by a visibly distinct (e.g., different shape or demarking feature) upper portion and a lower portion. A flange 50, which may generally be radial, horizontal, or frustoconical in shape is advantageously provided at or near a bottom of the nipple body 40. However, any conventional flange 50 or connecting member may be used in accord with the present concepts and the illustration is merely an example of one conventional flange which may be used in combination with a conventional threaded retaining ring to seal the bottom of the flange to an open or free edge of a bottle when the threaded retaining ring is matingly engaged and fastened to a corresponding thread on the bottle.

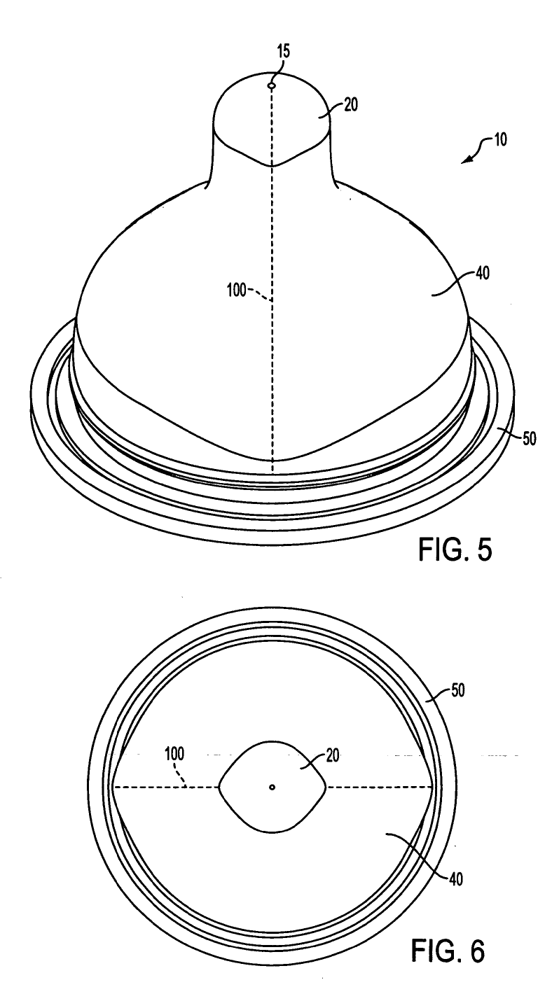

In accord with the present concepts, the nipple 10 has a shape that is non-circular in cross-section over at least a portion of the tip 20 and/or nipple body 40 by virtue of bi-lateral extensions 100 provided on opposing sides of the nipple. The angle α defined between bi-lateral extensions 100 is 180°, as shown in FIG. 4. However, the angle defined between bi-lateral extensions 100 may cover a wide range of angles to accommodate a wide range of anatomical structures (i.e., shapes of the lips and mouth). For example, the angle defined between bi-lateral extensions 100 may be 180°, 170°, 160°, 150°, 140°, 130°, or about 120°, or any angle therebetween. An example of such alternate configuration is represented by the dashed lines 101 shown in FIG. 4. It is generally preferred to provide an angle between bi-lateral extensions 100 of between about 180° and 160°, as this will accommodate the vast majority of anatomical structures, but this is by no means limiting to the broader range expressed above.

Moreover, nipple 10 is not constrained to rely only upon a single defined angle between bi-lateral extensions 100 and the angle between the bi-lateral extensions may be varied (linearly or non-linearly) over a length of the nipple (e.g., between a portion of the tip 20 and a portion of the nipple body 40) or over a portion thereof to enhance the flexibility of the nipple to adapt to a variety of anatomies. For example, the angle between the bi-lateral extensions 100 may be about 180° at a portion of the tip 20, about 170° at a middle portion of nipple body 40, and about 160° at a lower portion of the nipple body, with a substantially continuous increase in the angle between proximal end (near the tip) and distal end of the bi-lateral extensions. Conversely, the angle may increase between the proximal end and distal end of the bi-lateral extensions.

Turning to the structure of the bi-lateral extensions 100, FIGS. 1, 2 and 4 show one representation, wherein a substantially circular (in cross-section) nipple 10 is provided with bi-lateral extensions having a semicircular or curvilinear cross-section. Bi-lateral extensions may alternately possess an angled or substantially triangular cross-section, although the apex or vertex of such angled or substantially triangular cross-section would preferably be rounded to minimize irritation to the infant. The bi-lateral extensions 100 are, in essence, outwardly projecting deviations from a circular-cross section (or other base geometric profile) along selected angles. These bi-lateral extensions 100 may be disposed normally to the tangent of the circular cross-section to which they are attached or form a part, or may be disposed at an angle thereto, such as but not limited to a slightly downward inclination.

Thus, the addition of the bi-lateral extensions 100 to an otherwise conventional nipple 10 better approximates the actual shape of an infant's or baby's mouth, including the very corner of the mouth, during suckling or feeding.

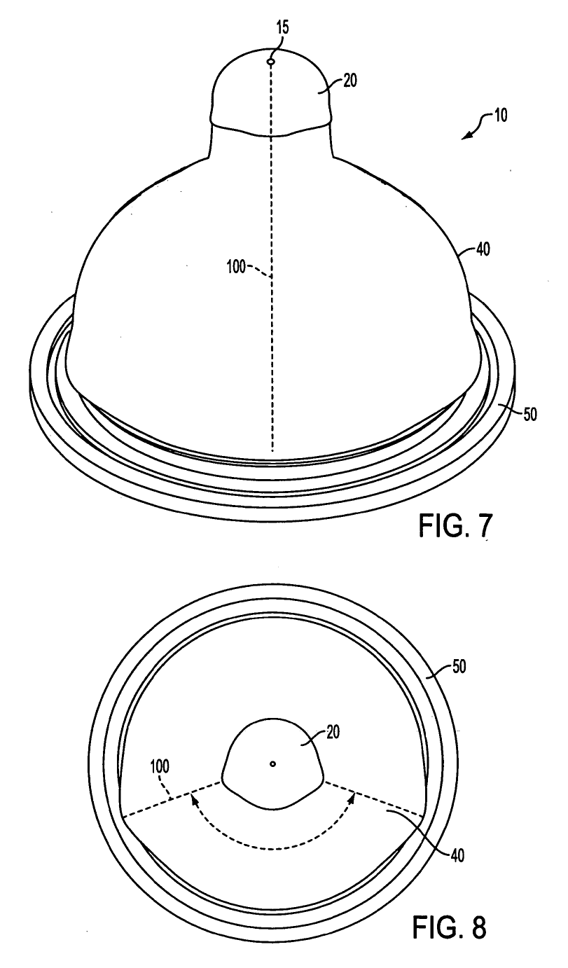

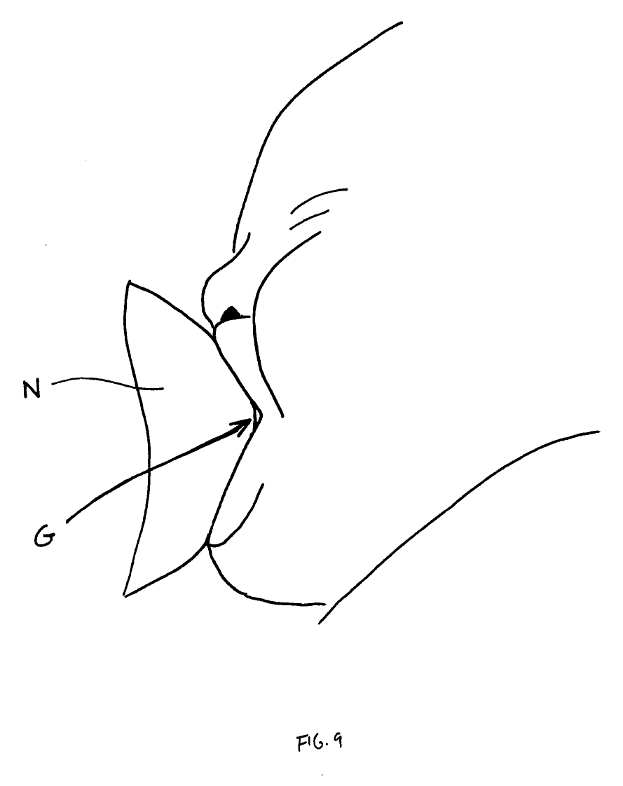

In another example, the nipple 10 itself is non-circular in cross-section, such as shown in FIGS. 5-6. This nipple 10 assumes a somewhat oblate shape having a longer axis along the “horizontal” or equatorial diameter, which corresponds to a lateral dimension of an infant's mouth, and a shorter axis along the “vertical” or polar diameter, which corresponds to a vertical dimension of an infant's mouth.

A switch the first example, the example of FIGS. 5-6 has a shape that is substantially circular in cross-section, but deviates from this circularity and is non-circular in cross-section over at least a portion of the tip 20 and/or nipple body 40 by virtue of bi-lateral extensions 100 formed into the overall structure of the nipple. The angle defined between bi-lateral extensions 100 is 180°, as shown in FIGS. 5-6, but may be any angle (or range of angles) between about 180° and 120°, and still more preferably between about 180° and 160°.

Nipple 10 is not constrained to rely only upon a single defined angle between bi-lateral extensions 100 and the angle between the bi-lateral extensions may be varied (linearly or non-linearly) over a length of the nipple (e.g., between a portion of the tip 20 and a lower portion of nipple body 40) as with the first example to enhance the flexibility of the nipple to adapt to a variety of anatomies. As with the previous example, this aspect may be realized by a nipple wherein the angle between the bi-lateral extensions 100 is a first angle at a portion of the tip 20 and a second angle at a portion of nipple body 40, the first angle and the second angle being different (e.g., greater or lesser) from one another.

The bi-lateral extensions 100 shown in FIGS. 5-6 are generally angled or triangular in shape, and possess a rounded or softened vertex to minimize irritation to the baby or infant. Bi-lateral extensions 100 basically comprise outwardly projecting deviations from a circular-cross section along a selected angle or angles along a portion of a length of the nipple 10. The maximum height of the bi-lateral extensions 100, which in one aspect corresponds to the deviation of the distal extent of the bi-lateral extensions from the circle defining the remainder of a selected cross-section of the nipple 10, is less than about 5.0 mm, and still more preferably between about 0.50 mm and 3.00 mm. In one aspect, the maximum height of the bi-lateral extensions 100 is between about 1.5 mm and 3.0 mm.

Nipple 10 and the concepts disclosed herein is in no way constrained to a substantially circular cross-section. Nipple 10 may be substantially ovoid or elliptical in cross-section or may be defined by a cross-section of any curvilinear or substantially curvilinear (e.g., including one or more flat portions) shape. For example, the upper surface of the nipple may be defined by one geometric construct (e.g., circular shape) and the lower surface of the nipple may be defined by another geometric construct (e.g., elliptical shape, or opposing curved sections having a concave curved section or flat section therebetween). In such instances, the aforementioned maximum height of the bi-lateral extensions 100 may be taken with respect to the base local curvilinear or substantially curvilinear shape.

Having thus described exemplary embodiments of the present invention, it should be noted by those skilled in the art that the disclosures herein are exemplary only and that alternatives, adaptations and modifications may be made within the scope of the present disclosure. For example, the nipple may comprise any shape including, but not limited to that depicted herein, such as a substantially tip-less design (i.e., the diameter of the nipple increases substantially constantly between the outlet opening of the nipple and the base so as not to provide a clearly demarked transition between the tip and the base). In another aspect, bi-lateral extensions 100 could comprise a plurality of discrete portions, such as bumps of a selected shape (e.g., semi-circular shape or oval) arranged sequentially along a lengthwise portion of a respective side of the nipple. The shape of the nipple can be significantly varied so long as the infant is able to properly latch and seal onto the nipple.

1. A nursing nipple adapted for attachment to a fluid-bearing container comprising;
a body portion;
a tip portion;
bi-lateral extensions provided on opposing sides of at least one of said body portion and said tip portion.

2. A nursing nipple adapted according to claim 1, further comprising a flange portion to facilitate connection of said nursing nipple to said fluid-bearing container.

3. A nursing nipple adapted according to claim 1, wherein an angle defined between said bi-lateral extensions is between about 100° and 180°.

4. A nursing nipple adapted according to claim 1, wherein an angle defined between said bi-lateral extensions is between about 1600 and 180°.

5. A nursing nipple adapted according to claim 1, wherein an angle defined between said bi-lateral extensions varies along said at least one of said body portion and said tip portion.

6. A nursing nipple adapted according to claim 5, wherein an angle defined between said bi-lateral extensions increases along said at least one of said body portion and said tip portion from a first angle to a second angle.

7. A nursing nipple adapted according to claim 5, wherein an angle defined between said bi-lateral extensions decreases along said at least one of said body portion and said tip portion from a first angle to a second angle.

8. A nursing nipple adapted according to claim 6, wherein said angle defined between said bi-lateral extensions increases at least one of linearly, non-linearly, continuously, and intermittently along said at least one of said body portion and said tip portion from a first angle to a second angle.

9. A nursing nipple adapted according to claim 7, wherein said angle defined between said bi-lateral extensions increases at least one of linearly, non-linearly, continuously, and intermittently along said at least one of said body portion and said tip portion from a first angle to a second angle.

10. A nursing nipple adapted according to claim 1, wherein said bi-lateral extensions comprise a raised portion having a cross-section that is at least one of substantially circular, curvilinear, angled, substantially triangular, elliptical, and rounded.

11. A nursing nipple adapted according to claim 10, wherein said bi-lateral extensions comprise a raised portion having a height between about 0.25 mm and 5.0 mm.

12. A nursing nipple adapted according to claim 10, wherein said bi-lateral extensions comprise a raised portion having a height between about 1.5 mm and 3.0 mm.

13. A nursing nipple adapted according to claim 1, wherein said body portion comprises a dorsal section having a cross-section defined by a first geometric construct and a ventral section defined by a second geometric construct.

14. A nursing nipple adapted according to claim 13, wherein said first geometric construct comprises at least one of a substantially circular and substantially elliptical cross-section and said second geometric construct comprises at least one of a substantially circular and substantially elliptical cross-section.

15. A nursing nipple adapted according to claim 13, wherein said first geometric construct comprises at least one of a substantially circular and substantially elliptical cross-section and said second geometric construct comprises another a substantially circular and substantially elliptical cross-section.

16. A nursing nipple adapted according to claim 13, wherein said first geometric construct comprises a concave curvilinear cross-section, and wherein said second geometric construct comprises a convex curvilinear cross-section.

17. A nursing nipple adapted according to claim 16, wherein said first geometric construct comprises a concave curvilinear cross-section, wherein said second geometric construct comprises a convex curvilinear cross-section, and wherein said first geometric construct comprises at least one of a substantially circular and substantially elliptical cross-section and said second geometric construct comprises a substantially elliptical cross-section.

18. An apparatus for reducing an infant's air-intake during feeding from a fluid-bearing container comprising;
a body portion for attachment to at least one of a nipple and a bottle;
bi-lateral extensions provided on opposing sides of at least one of the body portion and the tip portion.

19. A nursing nipple adapted for attachment to a fluid-bearing container comprising;
substantially bi-lateral extensions provided on opposing sides of the nursing nipple, said bi-lateral extensions extending along at least a portion of said nursing nipple.
